(19) United States
(12) Patent Application Publication
(10) Pub. No.: US 2007/0013322 A1
(43) Pub. Date: Jan. 18, 2007

(54) Led temperature-dependent power supply system and method

(75) Inventors: Ajay Tripathi, Schaumburg, IL (US); Bernd Clauberg, Schaumburg, IL (US)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/570,539

(22) PCT Filed: Sep. 1, 2004
(86) PCT No.: PCT/IB04/51654

§ 371 Date: Mar. 3, 2006

Related U.S. Application Data
(60) Provisional application No. 60/500,271, filed on Sep. 4, 2003.

(51) Int. Cl. H05B 41/36; G05F 1/00; H05B 39/04; H05B 37/02

(52) U.S. Cl. 315/291

(57) ABSTRACT

A LED based lighting system (20) employs a LED load temperature sensor (40) for generating a temperature-sensing signal (TSS) indicative of an operational temperature of the LED load (10), a LED current sensor (50) for generating a current-sensing signal (CSS) indicative of a flow of the LED current (I_{LED}) through the LED load (10), and a LED driver (30) for regulating the flow of the LED current (I_{LED}) through the LED load (10) as a function a mixture of the current-sensing signal (CSS) and the temperature-sensing signal (TSS). The system (20) can further employ a driver disable notifier (80) and a LED driver disabler (90), or alternatively, a fuse network (100) for disabling the LED driver (30) upon a detection of a fault condition of the system (20).

The present invention generally relates to light-emitting diode (“LED”) light sources. The present invention specifically relates to a power supply system for LED light sources employed within lighting devices (e.g., a traffic light).

Most conventional traffic lighting systems employ incandescent bulbs as light sources. Typically, a power disable notifying system is utilized to detect bulb malfunction. Unfortunately, energy consumption and maintenance of incandescent bulb systems is unacceptably high. As a result, LEDs are rapidly replacing incandescent bulbs as the light source for traffic signals. Typically, LEDs consume ten percent (10%) of the power consumed by incandescent bulbs when providing the same light output (e.g., 15 watts vs. 150 watts). Additionally, LEDs experience a longer useful life as compared to incandescent bulbs resulting in a reduction in maintenance.

The use of LEDs as the light source for traffic signals has resulted in development of LED power supplies, which convert an alternating current (AC) voltage input (e.g., 120 VAC) to a direct current (DC) voltage input. The present invention advances the art of supplying power to LED traffic lighting systems.

One form of the present invention is a LED temperature-dependent power supply system comprising a LED driver module, and a temperature-dependent current control module. The LED driver module regulates a flow of a LED current through a LED load as a function of a temperature-dependent feedback signal. The temperature-dependent current control module generates the temperature-dependent feedback signal as a function of the flow of LED current through the LED load and an operating temperature of the LED load. The temperature-dependent current control module is in electrical communication with the power supply to communicate the temperature-dependent feedback signal to the LED driver module.

The term “electrical communication” is defined herein as an electrical connection, electrical coupling or any other technique for electrically applying an output of one device (e.g., the temperature-dependent current control module) to an input of another device (e.g., the LED driver module).

A second form of the present invention is a LED temperature-dependent power supply method involving a generation of a current-sensing signal indicative of a flow of a LED current through a LED load, a generation of a temperature-sensing signal indicative of an operating temperature of the LED load, and a regulation of the flow of the LED current through the LED load as a function of a mixture of the current-sensing signal and the temperature-sensing signal.

The term “mixture” is defined herein as a generation of an output signal (e.g., the temperature-dependent feedback signal) having a mathematical relationship with each input signal (e.g., the current-sensing signal and the temperature-sensing signal).

The foregoing forms as well as other forms, features and advantages of the present invention will become further apparent from the following detailed description of the presently preferred embodiments, read in conjunction with the accompanying drawings. The detailed description and drawings are merely illustrative of the present invention rather than limiting, the scope of the present invention being defined by the appended claims and equivalents thereof.

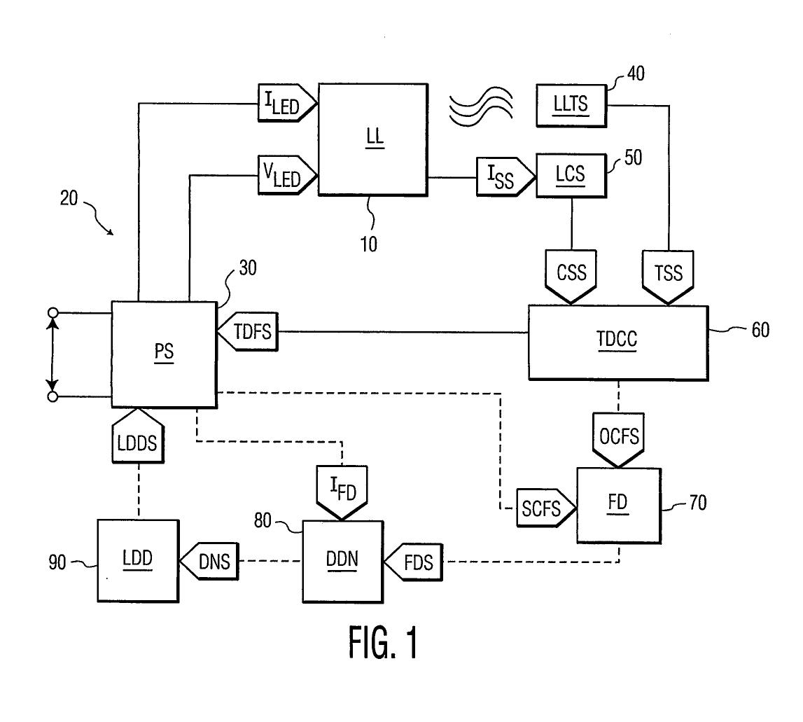

FIG. 1 illustrates a block diagram of a LED temperature-dependent power supply system in accordance with a first embodiment of the present invention;

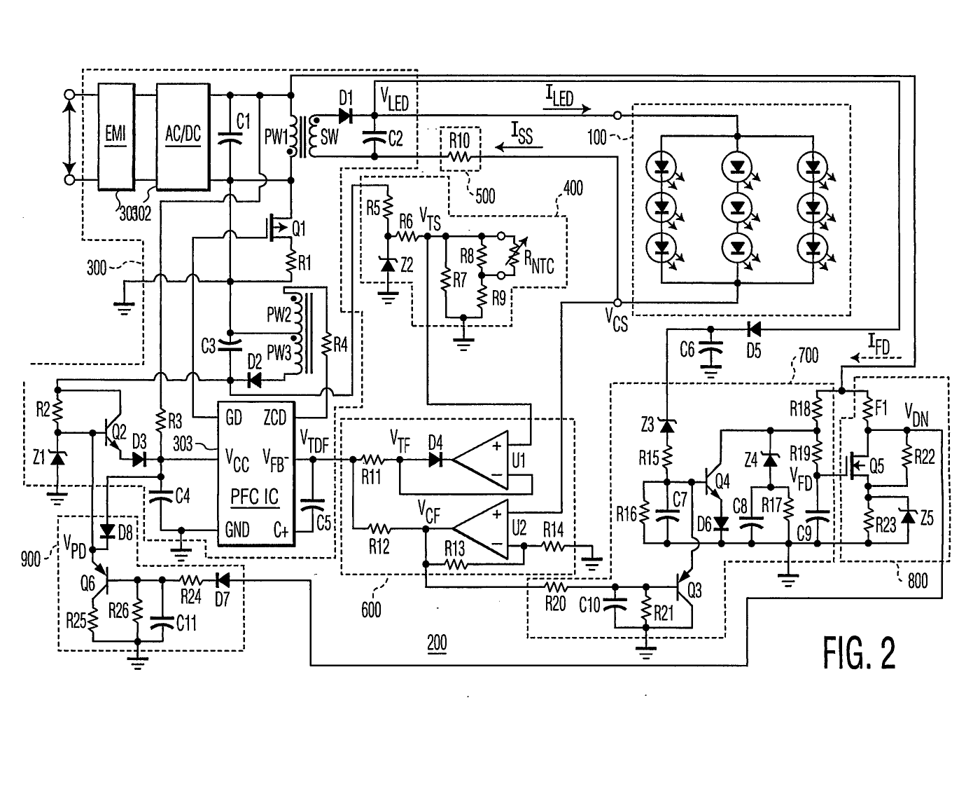

FIG. 2 illustrates one embodiment in accordance with the present invention of the LED temperature-dependent power supply system illustrated in FIG. 1;

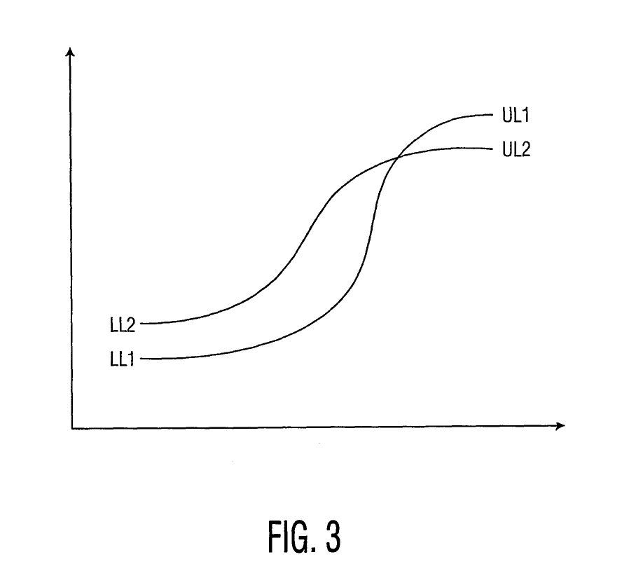

FIG. 3 illustrates an exemplary graphical relationship of a LED current and a negative temperature coefficient network illustrated in FIG. 2;

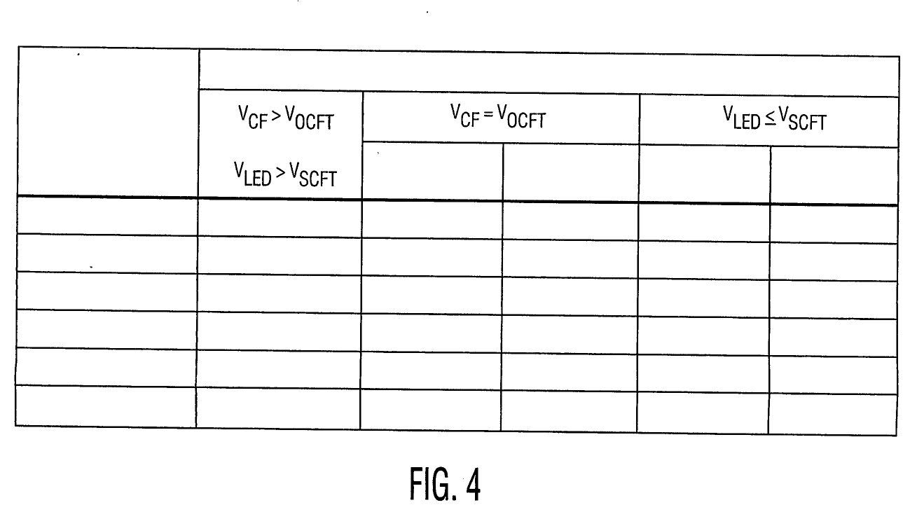

FIG. 4 illustrates a table listing various operational states of transistors employed by the temperature-dependent power supply system illustrated in FIG. 2;

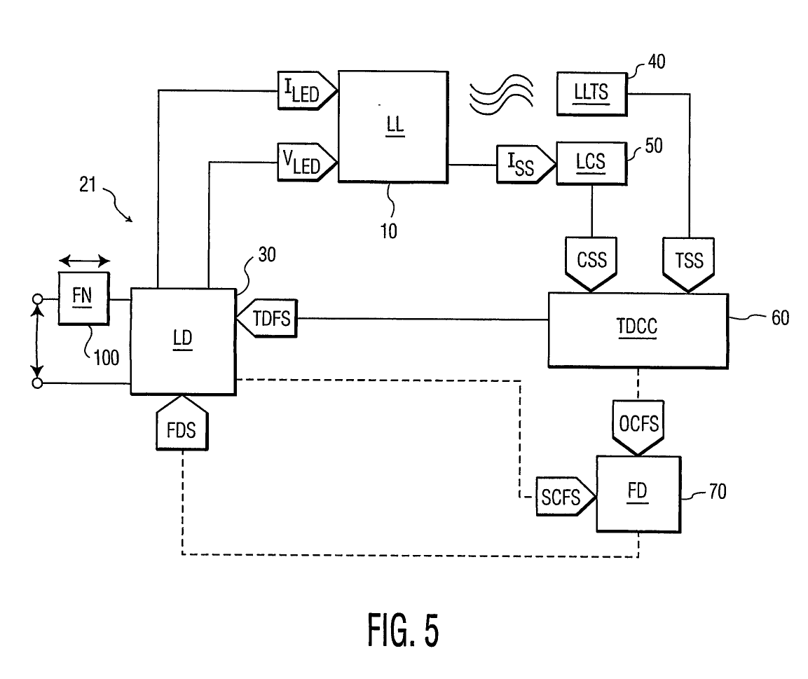

FIG. 5 illustrates a block diagram of a LED temperature-dependent power supply system in accordance with a second embodiment of the present invention;

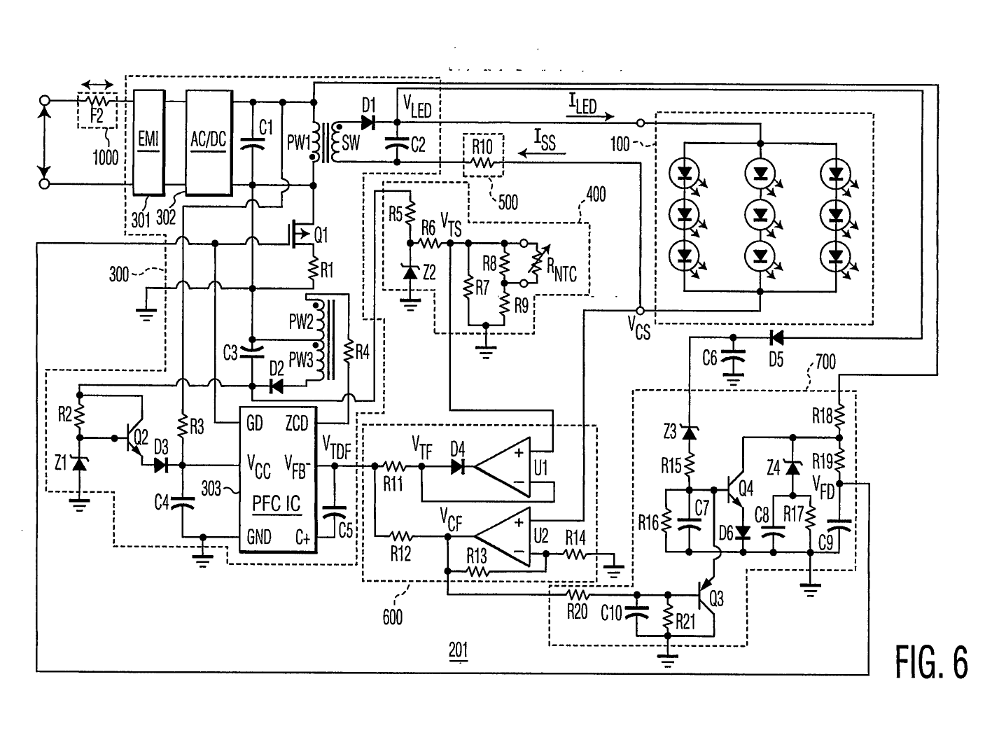

FIG. 6 illustrates one embodiment in accordance with the present invention of the LED temperature-dependent power supply system illustrated in FIG. 5; and

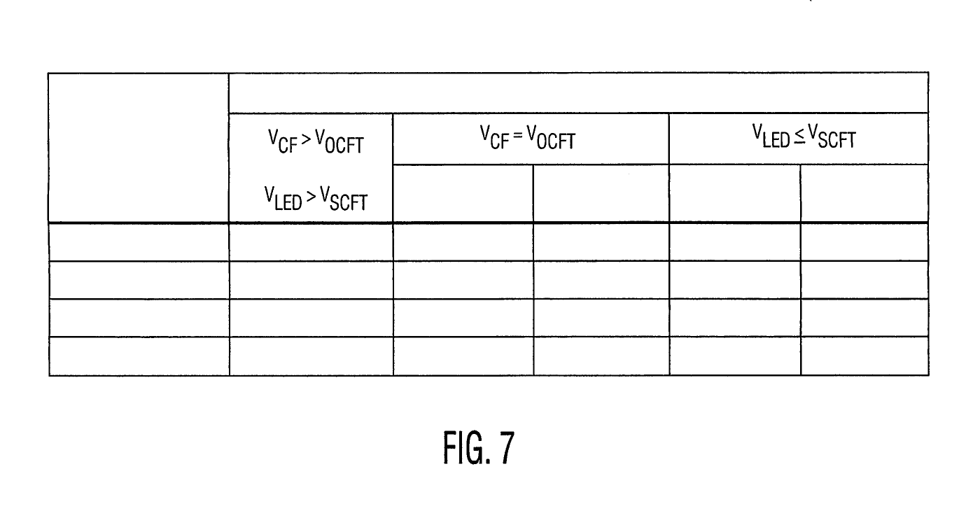

FIG. 7 illustrates a table listing various operational states of transistors employed by the temperature-dependent power supply system illustrated in FIG. 5.

A LED based lighting system 20 (e.g., a traffic light) as illustrated in FIG. 1 controls a flow of a LED current I_{LED} through a LED load (“LL”) 10 of one or more LEDs in response to an input voltage in the form of either an “ON” state input voltage V_{ON} or an “OFF” stage input voltage V_{OFF}. To this end, system 20 employs a LED driver (“LD”) 30, a LED load temperature sensor (“LLTS”) 40, a LED current sensor (“LCS”) 50, a temperature-dependent current controller (“TDCC”) 60, a fault detector (“FD”) 70, a driver disable notifier (“DDN”) 80 and a LED driver disabler (“LDD”) 90.

LED driver 30 is an electronic module structurally configured to apply a LED voltage V_{LED} to LED load 10 and to regulate a flow of LED current I_{LED} through LED load 10 as a function of operating temperature of LED load 10 and the flow of LED current I_{LED} through LED load 10 as indicated by a temperature-dependent feedback signal TDFS communicated to LED driver 30 by control controller 60. The amperage level of LED current I_{LED} exceeds a minimum forward current threshold for driving LED load 10 in emitting a light whenever the “ON” state input voltage V_{ON} is applied to LED driver 30. The amperage level of LED current I_{LED} is less than the minimum forward current threshold for driving LED load 10 in emitting a light whenever the “OFF” state input voltage V_{OFF} is applied to LED driver 30.

The manner in which LED driver 30 regulates the flow of LED current I_{LED} through the LED load 10 is without limit. In one embodiment, LED driver 30 implements a pulse-width modulation technique in regulating the flow of the LED current I_{LED} through LED load 10 where the implementation of the pulse-width modulation technique is based on temperature-dependent feedback signal TDFS.

LED driver 30 is also structurally configured in the to generate a short condition fault signal SCFS whenever LED load 10 is operating as a short circuit. LED driver 30 is in electrical communication with fault detector 70 to communicate short condition fault signal SCFS to fault detector 70 upon a generation of short condition fault signal SCFS by LED driver 30. In one embodiment, an operation of LED load 10 operating as a short circuit encompasses a low LED voltage condition whereby the voltage level of LED voltage V_{LED} is insufficient for driving LED load 10 in emitting a light during an application of the “ON” state input voltage V_{ON} to LED driver 30.

The manner in which LED driver 30 generates the short condition fault signal SCFS is without limit. In one embodiment, LED voltage V_{LED} is communicated to fault detector 70 whereby LED voltage V_{LED} being below a short condition fault threshold constitutes a generation of the short condition fault signal SCFS.

Sensor 40 is an electronic module structurally configured to sense an operating temperature of LED load 10, and to generate a temperature-sensing signal TSS that is indicative of the operating temperature of LED load 10 as sensed by sensor 40. Sensor 40 is in thermal communication with LED load 10 to thereby sense the operating temperature of LED load 10, and is in electrical communication with current controller 60 to communicate temperature-sensing signal TSS to current controller 60. The term “thermal communication” is defined herein as a thermal coupling, a spatial disposition, or any other technique for facilitating a transfer of thermal energy from one device (e.g., LED load 10) to another device (e.g., sensor 40).

The manner in which sensor 40 senses the operating temperature of LED load 10 and generates temperature-sensing signal is without limit. In one embodiment, sensor 40 employs an impedance network having a temperature-coefficient resistor, positive or negative, fabricated on a LED board supporting LED load 10 whereby the temperature-coefficient resistor is in thermal communication with LED load 10.

Sensor 50 is an electronic module structurally configured to sense the flow of LED current I_{LED} through LED load 10, and to generate a current-sensing signal CSS that is indicative of the flow of the LED current I_{LED} through LED load 10 as sensed by sensor 40. Sensor 50 is in electrical communication with current controller 60 to communicate current-sensing signal CSS to current controller 60.

The manner in which sensor 50 senses the flow of LED current I_{LED} through LED load 10, and generates current-sensing signal CSS is without limit. In one embodiment, sensor 50 is in electrical communication with LED load 10 to pull a sensing current I_{SS} from LED load 10 as illustrated in FIG. 1 whereby sensor 50 generates current sensing signal CSS based on sensing current I_{SS}.

Current controller 60 is an electronic module structurally configured to generate temperature-dependent feedback signal TDFS as a function of the operating temperature of the LED load 10 as indicated by temperature-sensing signal TSS and the flow of the LED current I_{LED} through LED load 10 as indicated by current-sensing signal CSS. Current controller 60 is in electrical communication with LED driver 30 whereby LED driver 30 regulates the flow of the LED current I_{LED} through LED load 10 as previously described herein.

The manner in which current controller 60 generates temperature-dependent feedback signal TDFS is without limit. In one embodiment, current controller 60 mixes the temperature sensing signal TSS and the current sensing signal CSS to yield the temperature-dependent feedback signal TDFS.

Current controller 60 is also structurally configured to generate an open condition fault signal OCFS whenever current sensing signal CSS indicates LED load 10 is operating as an open circuit Current controller 60 is in electrical communication with fault detector 70 to communicate open condition fault signal OCFS to fault detector 70 upon a generation of open condition fault signal OCFS by current controller 60.

The manner in which current controller 60 generates open condition fault signal OCFS is without limit. In one embodiment, current controller 60 generates open condition fault signal OCFS in response to current sensing signal CSS being below an open condition fault threshold.

Fault detector 70 is an electronic module structurally configured to generate a fault detection signal FDS as an indication of a generation of short circuit condition signal SCFS by LED driver 30 or a generation of open condition fault signal OCFS by current controller 60. Fault detector 70 is in electrical communication with driver disable notifier 80 to communicate fault detection signal FDS to driver disable notifier 80 upon a generation of fault detection signal FDS by fault detector 70.

The manner in which fault detector 70 generates fault detection signal FDS is without limit. In one embodiment, fault detector 70 employs one or more electronic switches that transition from a first state (e.g., an “OPEN” switch state) to a second state (e.g., “CLOSED” switch state) in response to either short circuit condition signal SCFS or open circuit condition signal OCFS being communicated to fault detector 70 by LED driver 30 or current controller 60, respectively.

Driver disable notifier 80 is an electronic module structurally configured to draw a fault detection current I_{FD} from LED driver 30 in response to a generation of fault detection signal FDS by fault detector 70, and to generate a disable notification signal DNS upon an amperage of fault detection current I_{FD} exceeding a fault detection threshold. Driver disable notifier 80 is in electrical communication with LED driver disabler 90 to communicate disable notification signal DNS to LED driver disabler 90 upon a generation of disable notification signal DNS by driver disable notifier 80.

The manner in which driver disable notifier 80 generates disable notification signal DNS is without limit. In one embodiment, driver disable notifier 80 employs one or more electronic switches that transition from a first state (e.g., an “OPEN” switch state) to a second state (e.g., “CLOSED” switch state) to pull fault detection current I_{FD} from LED driver 30 in response to fault detection signal FDS being communicated to driver disable notifier 80 by fault detector 70. This embodiment further employs a fuse component (e.g., a fusistor) whereby fault detection current I_{FD} will blow open the fusistor to generate the disable notification signal DNS.

LED driver disabler 90 is an electronic module structurally configured to generate a LED-driver disable signal LDDS as an indication of a generation of disable notification signal DNS by driver disable notifier 80. LED driver disabler 90 is in electrical communication with LED driver 30 to communicate LED driver disable signal LDDS to LED driver 30 upon a generation of LED driver disable signal LDDS by LED driver disabler 90.

The manner in which LED driver disabler 90 generates LED driver disable signal LDDS is without limit. In one embodiment, LED driver disabler 90 employs one or more electronic switches that transition from a first state (e.g., an “OPEN” switch state) to a second state (e.g., “CLOSED” switch state) to generate LED driver disable signal LDDS in response to disable notification signal DNS being communicated to LED driver disabler 90 by driver disable notifier 80.

An “ON” state operation and an “OFF” stage operation of system 20 will now be described herein.

An “ON” state operation of system 20 involves an application of “ON” state input voltage V_{ON} to LED driver 30 whereby LED driver 30 regulates the flow of LED current I_{LED} through LED load 10 to thereby drive LED load 10 to emit a light. This current regulation by LED driver 30 will vary between an upper limit and a lower limit for LED current I_{LED} based on the sensed operating temperature of LED load 10 and the sensed flow of LED current I_{LED} through LED load 10. This current regulation by LED load 10 will be continuous until such time (1) the “OFF” state input voltage V_{OFF} is applied to LED driver 30, (2) the LED load 10 operates as an open circuit, or (3) the LED load 10 operates as a short circuit, which, as previously described herein, encompasses a low LED voltage condition whereby the voltage level of LED voltage V_{LED} is insufficient for driving LED load 10 in emitting a light during an application of the “ON” state input voltage V_{ON} to LED driver 30. In one embodiment, if a fault condition is detected during the “ON” state operation, then fault detection current I_{FS} flows through a fuse component of driver disable notifier 80 until the fuse component blows open to thereby disable LED driver 30.

An “OFF” state operation of system 20 involves an application of an input voltage (not shown) via a high impedance network (not shown) (e.g., 20 KΩ). A conventional conflict monitor (not shown) is utilized to measure a voltage across input terminals of LED driver 30. In one embodiment, if a fuse component of driver disable notifier 80 had blown open during the “ON” state operation as an indication of a fault condition of system 20, then the voltage measured across the input terminals of LED driver 30 will exceed a conflict monitor voltage threshold for facilitating a detection of the fault condition by the conflict monitor. Conversely, if the fuse component of driver disable notifier 80 had not blow open during the “ON” state operation, then the voltage measured across the input terminals of LED driver 30 will be less than the conflict monitor voltage threshold whereby the conflict monitor detects a no-fault operation status of system 20.

In practice, structural configurations of LED driver 30, sensor 40, sensor 50, temperature-dependent current controller 60, fault detector 70, driver disable notifier 80 and LED driver disabler 90 are dependent upon a particular commercial implementation of system 20.

FIG. 2 illustrates one embodiment of system 20 (FIG. 1) as a system 200 that employs LED driver 300, sensor 400, sensor 500, a temperature-dependent current controller 600, a fault detector 700, a driver disable notifier 800 and a LED driver disabler 900.

LED driver 300 employs an illustrated structural configuration of a conventional electromagnetic filter (“EMI”) 301, a conventional power converter (“AC/DC”) 302, capacitors C1-C5, windings PW1-PW3 and SW1 of a transformer, diodes D1-D3, a zener diode Z1, resistors R1-R4, an electronic switch in the form of a N-Channel MOSFET Q1, an electronic switch in the form of a NPN bipolar transistor Q2, and a conventional power factor correction integrated circuit (“PFC IC”) 303 (e.g., model L.6561 manufactured by ST Microelectronics, Inc.).

Circuit 303 has a gate driver output GD electrically connected to a gate of MOSFET Q1 to control an operation of MOSFET Q1 as a switch. Reset coil PW2 is electrically connected to a reset input ZCD of circuit 303 to conventionally provide a reset signal (not shown) to circuit 303. An emitter terminal of transistor Q2 is electrically connected via diode D3 to power input V_{CC} of circuit 303 to conventionally provide a power signal (not shown) to circuit 303. Capacitor C5 is electrically connected between a feedback input V_{FB} and a compensation input C+ of circuit 303 to facilitate an application to feedback input V_{FB} of temperature-dependent feedback signal TDFS (FIG. 1) in the form of a temperature-dependent feedback voltage V_{TDFS}.

Sensor 400 employs an illustrated structural configuration of resistors R5-R9, a zener diode Z2, and a negative temperature coefficient resistor R_{NTC} A thermal communication between resistor R_{NTC} and a LED load 100 facilitates a generation of temperature sensing signal TSS (FIG. 1) in the form of a temperature sensing voltage V_{TS}. In one embodiment, resistor R_{NTC} is formed on a LED board supporting LED load 100 to thereby establish the thermal communication between resistor R_{NTC} and LED load 100.

The illustrated structural configuration of sensor 400 enables a selection of one of many LED operational relationships between the resistive value of resistor R_{NTC} and the flow of LED current I_{LED} through LED load 100. FIG. 3 illustrates a pair of exemplary curves depicting the operational relationships between the resistive value of resistor R_{NTC} and the flow of LED current I_{LED} through LED load 100. The first curve is shown as having an upper limit UL1 and a lower limit LL1. The second curve is shown as having an upper limit UL2 and a lower limit LL2. Those having ordinary skill in the art will appreciate the required light output of LED load 100 determines the desired operational relationship between the resistive value of resistor R_{NTC} and the flow of LED current I_{LED} through LED load 100.

Sensor 500 conventionally employs a sense resistor R10 to facilitate a generation of current sensing signal CSS (FIG. 1) in the form of current sense voltage V_{CS}.

Current controller 600 employs an operational amplifier U1, an operational amplifier U2, resistors R11-R14, and a diode D4. A non-inverting input of operational amplifier U1 is electrically connected to sensor 400 whereby temperature-sensing voltage V_{TS} is applied to the non-inverting input of operational amplifier U1. A non-inverting input of operational amplifier U2 is electrically connected to sensor 500 whereby current sensing voltage V_{CS} is applied to the non-inverting input of operational amplifier U2. Temperature-dependent feedback voltage V_{TDF} is generated as a mixture of a temperature feedback voltage V_{TF} generated by operational amplifier U1 and a current feedback voltage V_{CF} generated by operational amplifier U2.

In one embodiment, an internal reference signal of circuit 303 is 2.5 volts and the illustrated structural configuration of current controller 600 is designed to force temperature-dependent feedback voltage V_{TDF} to be 2.5 volts. In design, at the lower end of the operating temperature range of LED load 100 operational amplifier U1 is designed to generate temperature sensing voltage V_{TS} approximating 2.5 volts and a design of an output of operational amplifier U2 in generating current sensing voltage V_{CS} is adjusted to achieve a lower LED current limit, such as, for example, lower limits LL1 and LL2 illustrated in FIG. 3. In operation, the generation of temperature sensing voltage V_{TS} and current sensing voltage V_{CS} is in accordance with the mathematical relationship [1]:
(V_{CF}−2.5 volts)/R12=(2.5 volts−V_{TF})/R11 [1]

where a minimum level of temperature sensing signal V_{TS} achieves a suitable upper LED current limit, such as, for example upper limits UL1 and UL2 illustrated in FIG. 3.

Fault detector 700 employs an illustrated structural configuration of resistors R15-R21, capacitors C7-C10, a diode D6, a pair of zener diode Z3 and Z4, an electronic switch in the form of a PNP bipolar transistor Q3, and an electronic switch in the form of a NPN bipolar transistor Q4.

Resistor R20 is electrically connected to the output of operational amplifier U2 to establish the electric communication between current controller 600 and fault detector 700. Current sensing voltage V_{CS} is below the open condition fault threshold OCFT (e.g., 0 volts) whenever LED load 100 is operating as a short circuit. As such, current sensing voltage V_{CF} constitutes open condition fault signal OCFS (FIG. 1) whenever current sensing voltage V_{CF} below the open condition fault threshold.

Zener diode Z3 is electrically connected to an output of LED driver 300 via a diode D5 and a capacitor C6 to establish an electrical communication between LED driver 300 and fault detector 700. LED voltage V_{LED} constitutes the short circuit fault signal SCFS (FIG. 1) whenever LED voltage V_{LED} is below the short condition fault threshold SCFT (e.g., 4 volts), such as, for example, whenever LED load is operating as a short circuit.

Driver disable notifier 800 employs an illustrated structural configuration of fusistor F1, resistors R22 and R23, zener diode Z5, and an electronic switch in the form of a N-Channel MOSFET Q5. Fusistor F1 is electrically connected to LED driver 300 to thereby establish an electrical communication between LED driver 300 and driver disable notifier 800. A gate terminal of MOSFET Q5 is electrically connected to fault detector 700 to establish an electrical communication between fault detector 700 and driver disable notifier 800.

A fault detection current I_{FD} flows from LED driver 300 through fusistor F1 whenever MOSFET Q5 is ON. Fusistor F1 is designed to blow whenever the flow of fault detection current I_{FD} reaches a specified amperage level. Disable notification signal DNS (FIG. 1) in the form of a disable notification voltage V_{DN} is generated upon a blowing of fusistor F1.

LED driver disabler 900 employs the illustrated structural configuration of resistors R24-R26, a capacitor C11, a pair of diodes D7 and D8, and an electronic switch in the form of PNP bipolar transistor Q6. Diode D7 is electrically connected to fusistor F1 to thereby establish an electrical communication between driver disable notifier 800 and LED driver disabler 900. An emitter terminal of transistor Q6 and diode D8 are electrically connected to a base terminal of transistor Q2, and diode D8 is further electrically connected to power input V_{CC} of circuit 303 to establish an electrical communication between LED driver 300 and LED driver disabler 900. Power disable signal PDS (FIG. 1) in the form of power disable voltage V_{PD} is generated at the base terminal of transistor Q2 upon a generation of disable notification voltage V_{DN} by driver disable notifier 800.

An “ON” state operation of system 200 will now be described herein with reference to FIG. 4.

An “ON” state operation of system 200 involves an application of “ON” state input voltage V_{ON} to EMI filter 301 whereby LED driver 300 regulates the flow of LED current I_{LED} through LED load 100 to thereby drive LED load 100 to emit a light. Current feedback voltage V_{CF} being greater than an open condition fault threshold voltage V_{OCFT} is indicative of an absence of LED load 100 operating as an open circuit. LED voltage V_{LED} being greater than short condition fault threshold voltage V_{SCTF} is indicative of an absence of LED load 100 operating in a low LED voltage condition, in particular as a short circuit. As such, MOSFET Q1 and transistor Q2 are turned ON whereby circuit 303 controls an implementation of a pulse width modulation of the gate signal applied to MOSFET Q1.

Current feedback voltage V_{CF} being equal to open condition fault threshold voltage V_{OCFT} is indicative of a presence of LED load 100 operating as an open circuit. In such a case, transistor Q3 is turned ON, which turns transistor Q4 OFF. This ensures MOSFET Q5 is fully turned ON. As a result, fault detection current I_{FD} will flow through fusistor F1 until fusistor F1 is blown open. Upon fusistor F1 blowing open, transistor Q6 is turned ON to thereby turn pull the base terminal of transistor Q2 and capacitor C4 to a low voltage state whereby LED driver 300 is disabled and MOSFET Q1 is turned OFF.

LED voltage V_{LED} being less than or equal to short condition fault threshold voltage V_{SCFT} is indicative of a presence of LED load 100 operating in a low LED voltage condition, particularly as a short circuit. In this case, transistor Q4 turns OFF to turn MOSFET Q5 fully ON. As a result, fault detection current I_{FD} will flow through fusistor F1 until fusistor F1 is blown open. Again, upon fusistor F1 blowing open, transistor Q6 is turned ON to thereby turn pull the base terminal of transistor Q2 and capacitor C4 to a low voltage state whereby LED driver 300 is disabled and MOSFET Q1 is turned OFF.

If a fault condition is detected during the “ON” state operation, then fusistor F1 is blown and LED driver 30 is disabled. Specifically, fusistor F1 is blown open by keeping MOSFET Q5 turned on whereby fault detection current I_{FD} increases until fusistor F1 blows open.

An “OFF” state operation of system 200 involves an application of an input voltage (not shown) via a high impedance network (not shown) (e.g., 20 KΩ). A conventional conflict monitor (not shown) is utilized to measure a voltage across input terminals of LED driver 300. If fusistor F1 had blown open during the “ON” state operation as an indication of a fault condition of system 200, then the voltage measured across the input terminals of LED driver 300 will exceed a conflict monitor voltage threshold for facilitating a detection of the fault condition by the conflict monitor. If fusistor F1 had not blow open during the “ON” state operation, then the conflict monitor voltage measured across the input terminals of LED driver 300 will be less than the voltage threshold whereby the conflict monitor detects a no-fault operation status of system 200.

A LED based lighting system 21 (e.g., a traffic light) as illustrated in FIG. 5 controls a flow of a LED current I_{LED} through a LED load (“LL”) 10 in response to an input voltage in the form of either an “ON” state voltage V_{ON} or an “OFF” stage voltage V_{OFF}. To this end, system 20 employs power supply (“PS”) 30, LED load temperature sensor (“LLTS”) 40, LED current sensor (“LCS”) 50, a temperature-dependent current controller (“TDCC”) 60, fault detector (“FD”) 70, and a fuse network (“FD”) 100.

LED driver 30, sensor 40, sensor 50, current controller 60 and fault detector 70 operate as previously described herein in connection with FIG. 1, except fault detector 70 is in electrical communication with LED driver 30 to communicate fault detection signal FDS to LED driver 30. In response to fault detection signal FDS, LED driver 30 operates to increase an amperage level of an input current I_{IN} whereby fuse network 100, which is an electronic module structurally configured to include one or more fuse components (e.g., a fusistor), blows open to disable LED driver 30.

An “ON” state operation and an “OFF” stage operation of system 21 will now be described herein.

An “ON” state operation of system 20 involves an application of “ON” state input voltage V_{ON} to LED driver 30 via fuse network 100 whereby LED driver 30 regulates the flow of LED current I_{LED} through LED load 10 to thereby drive LED load 10 to emit a light. This current regulation by LED driver 30 will vary between an upper limit and a lower limit for LED current I_{LED} based on the sensed operating temperature of LED load 10 and the sensed flow of LED current I_{LED} through LED load 10. This current regulation by LED load 10 will be continuous until such time (1) the “OFF” state input voltage V_{OFF} is applied to LED driver 30, (2) the LED load 10 operates as an open circuit, or (3) the LED load 10 operates as a short circuit, which, as previously described herein, encompasses a low LED voltage condition whereby the voltage level of LED voltage V_{LED} is insufficient for driving LED load 10 in emitting a light during an application of the “ON” state input voltage V_{ON} to LED driver 30.

An “OFF” state operation of system 21 involves an application of an input voltage (not shown) via a high impedance network (not shown) (e.g., 20 KΩ). A conventional conflict monitor (not shown) is utilized to measure a voltage across input terminals of LED driver 30. In one embodiment, if fuse network 100 had blown open during the “ON” state operation as an indication of a fault condition of system 21, then the voltage measured across the input terminals of LED driver 30 will exceed a conflict monitor voltage threshold for facilitating a detection of the fault condition by the conflict monitor. Conversely, if the fuse network 100 had not blow open during the “ON” state operation, then the voltage measured across the input terminals of LED driver 30 will be less than the conflict monitor voltage threshold whereby the conflict monitor detects a no-fault operation status of system 21.

Alternatively, the conflict monitor could measure an “ON” state input line current I_{IN} to detect any fault condition of system 21. In the case, if fuse network 100 blows open during the “ON” state operation, then the ON” state input line current I_{IN} will be less than a conflict monitor current threshold for facilitating a detection of the fault condition by the conflict monitor. Conversely, if the fuse network 100 does not blow open during the “ON” state operation, then the ON” state input line current I_{IN} will be greater than the conflict monitor current threshold whereby the conflict monitor detects a no-fault operation status of system 21.

In practice, structural configurations of LED driver 30, sensor 40, sensor 50, temperature-dependent current controller 60, fault detector 70, and fuse network 100 are dependent upon a particular commercial implementation of system 20.

FIG. 6 illustrates one embodiment of system 21 (FIG. 5) as a system 201 that employs LED driver 300, sensor 400, sensor 500, temperature-dependent current controller 600, fault detector 700, and a fuse network 1000. LED driver 300, sensor 400, sensor 500, current controller 600 and fault detector 700 operate as previously described in connection with FIG. 2. Fuse network 1000 includes a fusistor F2 electrically connected in series between an input terminal and EMI filter 301.

An “ON” state operation of system 201 will now be described herein with reference to FIG. 7.

An “ON” state operation of system 201 involves an application of “ON” state input voltage V_{ON} to EMI filter 301 via fusistor F2 whereby LED driver 300 regulates the flow of LED current I_{LED} through LED load 100 to thereby drive LED load 100 to emit a light. Current feedback voltage V_{CF} being greater than an open condition fault threshold voltage V_{OCFT} is indicative of an absence of LED load 100 operating as an open circuit LED voltage V_{LED} being greater than short condition fault threshold voltage V_{SCTF} is indicative of an absence of LED load 100 operating in a low LED voltage condition, in particular as a short circuit. As such, MOSFET Q1 and transistor Q2 are turned ON whereby circuit 303 controls an implementation of a pulse width modulation of the gate signal applied to MOSFET Q1.

Current feedback voltage V_{CF} being equal to open condition fault threshold voltage V_{OCFT} is indicative of a presence of LED load 100 operating as an open circuit. In such a case, transistor Q3 is turned ON, which turns transistor Q4 OFF. As a result, fault detection voltage V_{FD} is applied to the gate to MOSFET Q1 to thereby pull input current I_{IN} at amperage level sufficient to blow open fusistor F2.

LED voltage V_{LED} being less than or equal to short condition fault threshold voltage V_{SCFT} is indicative of a presence of LED load 100 operating in a low LED voltage condition, particularly as a short circuit. In such a case, transistor Q4 turns OFF to apply fault detection voltage V_{FD} to the gate terminal of MOSFET Q1 whereby LED driver 300 pulls input current I_{IN} at amperage level sufficient to blow open fusistor F2.

An “OFF” state operation of system 201 involves an application of an input voltage (not shown) via a high impedance network (not shown) (e.g., 20 KΩ). A conventional conflict monitor (not shown) is utilized to measure a voltage across input terminals of LED driver 300 In one embodiment, if fusistor F2 had blown open during the “ON” state operation as an indication of a fault condition of system 201, then the voltage measured across the input terminals of LED driver 300 will exceed a conflict monitor voltage threshold for facilitating a detection of the fault condition by the conflict monitor. Conversely, if fusistor F2 had not blow open during the “ON” state operation, then the voltage measured across the input terminals of LED driver 300 will be less than the conflict monitor voltage threshold whereby the conflict monitor detects a no-fault operation status of system 201.

Alternatively, the conflict monitor could measure an “ON” state input line current I_{IN} to detect any fault condition of system 201. In the case, if fusistor F2 blows open during the “ON” state operation, then the ON” state input line current I_{IN} will be less than a conflict monitor current threshold for facilitating a detection of the fault condition by the conflict monitor. Conversely, if fusistor F2 does not blow open during the “ON” state operation, then the ON” state input line current I_{IN} will be greater than the conflict monitor current threshold whereby the conflict monitor detects a no-fault operation status of system 201.

While the embodiments of the invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

1. A system (20) for supplying power to an LED load (10), the system (20) comprising:
a LED driver module (30) operable to regulate a flow of a LED current (I_{LED}) through the LED load (10) as a function of a temperature-dependent feedback signal (TDFS); and
a current controller module (60) in electric communication with said LED driver module (30) to communicate the temperature-dependent feedback signal (TDFS) to said LED driver module (10),
wherein said current controller module (60) is operable to generate the temperature-dependent feedback signal (TDFB) as a function of an operating temperature of the LED load (10) and the flow of the LED current (I_{LED}) through the LED load (10).

2. The system (20) of claim 1, wherein said current controller module (600) includes:
means for generating a temperature feedback voltage (V_{TF}) as a function of a sensed operating temperature of the LED load (10);
means for generating a current feedback voltage (V_{CF}) as a function of a sensed flow of the LED current (ILED) through the LED load (10); and
means for mixing the temperature feedback voltage (V_{TF}) and the current feedback voltage (V_{CF}) to yield the temperature-dependent feedback signal (TDFB)

3. The system (20) of claim 1, wherein said current controller module (600) includes:
an operational amplifier (U1) operable to generate a temperature feedback voltage (V_{TF}) as a function of the operating temperature of the LED load (10).

4. The system (20) of claim 3, further comprising:
a LED temperature sensor module (40) operable to sense the operating temperature of the LED load (10) and to generate a temperature sensing signal (TSS) indicative of the operating temperature of the LED load (10) as sensed by said LED temperature sensor module (40),
wherein said LED temperature sensor (40) is in electrical communication with said current controller module (60) to communicate the temperature-sensing signal (TSS) to said operational amplifier (U1) whereby said operational amplifier (U1) generates the temperature feedback voltage (V_{TF}) as a function of the operating temperature of the LED load (10).

5. The system (20) of claim 4, wherein said temperature sensor module (40) includes:
a temperature coefficient resistor (R_{NTC}) in thermal communication with the LED load (10) to thereby sense the operating temperature of the LED load.

6. The system (20) of claim 1, wherein said current controller module (60) includes:
an operational amplifier (U2) operable to generate a current feedback voltage (V_{CF}) as a function of the flow of the LED current (I_{LED}) through the LED load (10).

7. The system (20) of claim 6, further comprising:
a LED current sensor module (50) operable to sense the flow of the LED current (I_{LED}) through the LED load (10) and to generate a current sensing signal (CSS) indicative of the flow of the LED current (I_{LED}) through the LED load (10) as sensed by said LED current sensor module (50),
wherein said LED current sensor module (50) is in electrical communication with said current controller module (60) to communicate the current sensing signal (CSS) to said operational amplifier (U2) whereby said operational amplifier (U2) generates the current feedback voltage (V_{CF}) as a function of the flow of the LED current (I_{LED}) through the LED load (10).

8. The system (20) of claim 1, further comprising:
a fault detector module (70) operable to generate a fault detection signal (FDS) in response to the LED load (10) operating as an open circuit; and
a driver disable notifier (80) in electrical communication with said fault detector module (70) to receive a communication of the fault detection signal (FDS) from said fault detector module (70), said driver disable notifier (80) including a fusistor (F1) operable to blow open in response to a reception of the fault detection signal (FDS) by said driver disable notifier (80).

9. The system (20) of claim 8, further comprising:
a LED driver disabler module (90) operable to disable said LED driver module (30) in response to a blowing open of said fusistor (F1).

10. The system (20) of claim 1, further comprising:
means for generating a fault detection voltage (V_{FD}) as a function of the LED load (10) operating as an open circuit; and
a driver disable notifier (80) including
a fusistor (F1), and
means for blowing open said fusistor (F1) in response to a generation of the fault detection voltage (V_{FD}).

11. The system (20) of claim 10, further comprising:
means for disabling said LED driver module (30) in response to a blowing open of said fusistor (F1).

12. The system (20) of claim 1, further comprising:
a fault detector module (70) operable to generate a fault detection signal (FDS) in response to the LED load (10) operating as a short circuit; and
a driver disable notifier (80) in electrical communication with said fault detector module (70) to receive a communication the fault detection signal (FDS) by said fault detector module (70), said driver disable notifier (80) including a fusistor (F1) operable to blow open in response to a reception of the fault detection signal (FDS) by said driver disable notifier (80).

13. The system (20) of claim 12, further comprising:
a LED driver disabler module (90) operable to disable said LED driver module (30) in response to a blowing open of said fusistor (F1).

14. The system (20) of claim 1, further comprising:
means for generating a fault detection voltage (V_{FD}) as in response to the LED load (10) operating as a short open circuit; and
a driver disable notifier (80) including
a fusistor (F1), and
means for blowing open in response to a generation of the fault detection voltage (V_{FD}).

15. The system (20) of claim 14, further comprising:
means for disabling said LED driver module (30) in response to a blowing open of said fusistor (F1).

16. The system (20) of claim 1, further comprising:
a fusistor (F2) in electrical communication with said LED driver module (30),
wherein said fusistor (F2) is operable to blow open in response to the LED load (10) operating as an open circuit, and
wherein said LED driver module (30) is disabled in response to a blowing open of said fusistor (F2).

17. The system (20) of claim 1, further comprising:
a fusistor (F2) in electrical communication with said LED driver module (30),
wherein said fusistor (F2) is operable to blow open in response to the LED load (10) operating as a short circuit, and
wherein said LED driver module (30) is disabled in response to a blowing open of said fusistor (F2).

18. A method for supplying power to an LED load (10), the method comprising:
generating a current-sensing signal (CSS) indicative of a flow of a LED current (I_{LED}) through the LED load (10);
generating a temperature-sensing signal (TSS) indicative of an operational temperature of the LED load (10); and
regulating the flow of the LED current (I_{LED}) through the LED load (10) as a function a mixture of the current-sensing signal (CSS) and the temperature-sensing signal (TSS).

19. The method of claim 18, further comprising:
monitoring the operating condition of the LED load (10); and
ceasing the flow of the LED current (I_{LED}) through the LED load (10) in response to the LED load (10) operating as one of an open circuit or a short circuit.

20. The method of claim 19, further comprising:
blowing open a fusistor (F1, F2) in response to the LED load (10) operating as one of an open circuit or a short circuit; and
ceasing the flow of the LED current (I_{LED}) through the LED load (10) in response to the fusistor (F1, F2) being blow open.
